(19) United States
(12) Patent Application Publication
(10) Pub. No.: US 2007/0235274 A1
(43) Pub. Date: Oct. 11, 2007

(54) Composite helmet for body mount

(76) Inventor: Kevin Nicholls, London (CA)

Correspondence Address: FAY SHARPE/LUCENT, 1100 SUPERIOR AVE, SEVENTH FLOOR, CLEVELAND, OH, 44114, US

(21) Appl. No.: 11/726,232

(22) Filed: Mar. 21, 2007

Related U.S. Application Data
(63) Continuation of application No. 10/503,559, filed on Aug. 3, 2004, now abandoned.
(60) Provisional application No. 60/354,161, filed on Feb. 4, 2002.

(51) Int. Cl. F16F 9/00

(52) U.S. Cl. 188/321.11

(57) ABSTRACT

A composite helmet is provided for a body mount. The helmet includes an interior structural load bearing skeleton including an elongated cylinder, and a disk or washer mold-bonded with the polymeric or elastomeric portion of the helmet. The elastomeric portion of the helmet includes an elongated axial portion that encompasses the metal cylinder and an over-mold layer, if desired, over the metal disk. In some instances, a ring is incorporated into the shroud for increased strength and rigidity.

This application claims the priority benefit of and hereby expressly incorporates by reference U.S. provisional application Ser. No. 60/354,161, filed Feb. 4, 2002.

### BACKGROUND OF THE INVENTION

The present invention is directed to a body mount or cushion assembly for an automotive vehicle or truck. More particularly, the present invention is directed to a body mount assembly used to insulate or cushion vibration and shock between the frame and vehicle components.

Body on frame vehicles, including trucks, typically include body mounts disposed between the vehicle components and the frame to provide cushioning therebetween. The body mount typically includes a shock absorbing or vibration absorbing material (a cushioning assembly) such as an elastomeric member and a shell or helmet formed of sheet metal that overlies or enshrouds the elastomeric member. The helmet is typically constructed as a single piece of deep-drawn steel. This is a tooling intensive process and requires the designer to provide sufficient material thickness to achieve suitable crush loads.

The deep-drawn helmet is generally bell-shaped and when contacted occasionally produces an undesirable clanging. Thus, noise reduction associated with the mount assembly is desirable.

Forming the entire helmet of metal substantially adds to the mass of the overall mount assembly. A reduction in the use or amount of metal used in the mount assembly would contribute to weight reduction associated with the vehicle.

In addition, known body mounts require plating on the metal components thereof to increase corrosion resistance. Alternative strategies of providing an effective body mount that has increased corrosion resistance without sacrificing performance is always desired.

In addition, ease of assembly is a goal associated with mass production of a vehicle. Thus, any modification to the mount assembly needs to address issues regarding ease of manufacture and assembly.

The mount assembly can also be tuned to address different forces in the fore and aft directions, as well as laterally. Different vehicles using essentially the same mount assembly experience different forces. Thus, it is desirable to provide desired tuning to allow greater flexibility in system design.

### SUMMARY OF INVENTION

A composite helmet assembly of a vibration isolator or mount assembly manufactured in accordance with the teachings of the present invention has a substantially reduced mass than a comparable steel version.

The composite helmet assembly includes an inner skeleton of distinct structural load bearing components that are joined together. For example, an annular plate and an elongated cylinder are mold bonded together in an integrally molded helmet. This assembly is received over the shank of a mounting bolt, and cooperates with an upper cushion assembly disposed on one side of the frame and assembled to a lower cushion member or body mount assembly on the other side of the frame.

Increased tuning flexibility is also achieved with this arrangement as a result of the wide array of capabilities of the molded component.

A common structural load bearing assembly or skeleton may be used without sacrificing tuning abilities.

Another benefit resides in the potential to significantly reduce tool cost and lead time by eliminating expensive and complicated deep-draw dies.

The composite helmet allows for increased flexibility in loaded height, i.e., the component is not constricted by deep-draw shapes.

An opening through the upper cushion assembly may be dimensioned to provide a temporary retention force that maintains the individual components in pre-assembled relation to facilitate final assembly.

A primary advantage of the invention resides in reduction in mass of the assembly.

Still another advantage of the invention is the ability to eliminate any anti-corrosion coating.

Still another advantage resides in the temporary bolt retention feature to simplify assembly.

Increased friction between the cushion and the helmet leads to a more constant vibration damping rate over time.

Still other features and advantages of the invention will become apparent to one skilled in the art upon reading and understanding the following detailed description.

### BRIEF DESCRIPTION OF DRAWINGS

FIG. 1 is a longitudinal cross-sectional view of a composite helmet body mount.

FIG. 2 is an exploded view of the individual components shown assembled in FIG. 1.

FIG. 3 is a perspective view of the composite helmet with select portions cut away for ease of illustration.

FIG. 4 is a view similar to FIG. 3 with selected portions of the composite helmet removed and illustrating the underside of the helmet.

### DETAILED DESCRIPTION OF THE INVENTION

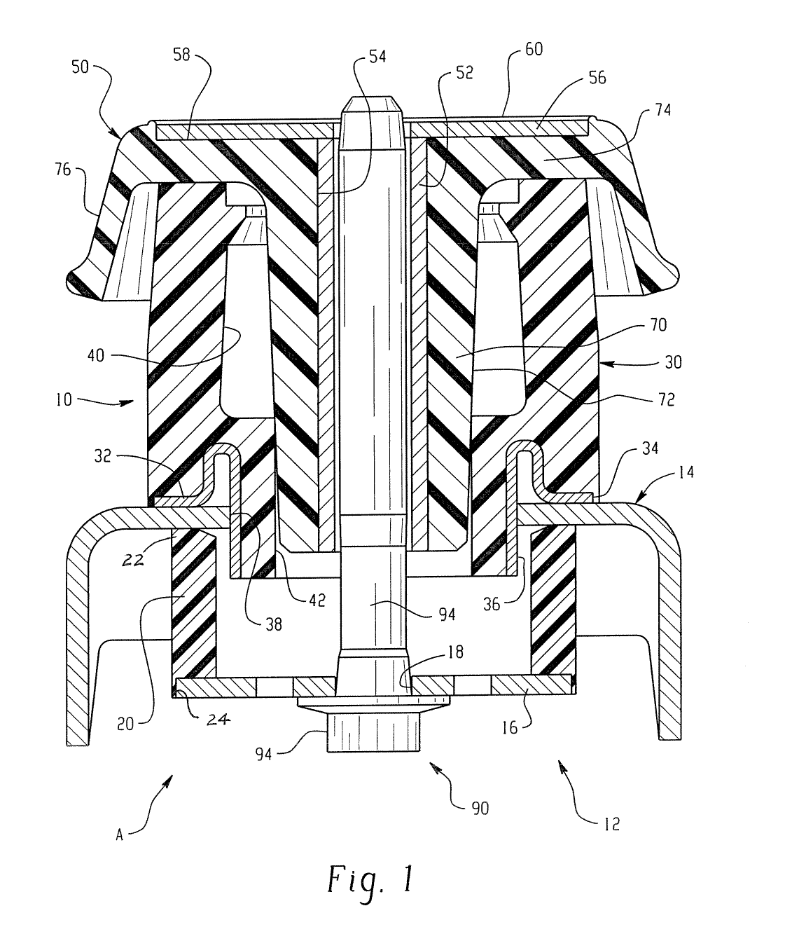

Turning initially to FIG. 1, the assembled body mount assembly A is illustrated. It includes a first or upper body mount portion 10 and a second or lower body mount portion 12 disposed on opposite sides of a vehicle frame 14. The lower body mount portion, also referred to as a rebound cushion assembly, includes a metal clamp disk 16 having a central opening 18 for mounting purposes. The metal clamp disk abuttingly engages cushion member 20, preferably an elastomeric material that provides desired energy damping or vibration attenuation. As shown here, the lower cushion member is a generally cylindrical structure that abuts a surface of the frame at a first or upper end 22 and may include a recess at a second or lower end 24 for receipt of or abutting engagement with the metal disk. Of course, one skilled in the art will appreciate the lower cushion member may adopt a wide variety of configurations as may be required for a particular design. For example, the lower cushion may be configured to provide different rates of attenuation in different directions, or provide multiple cushioning rate ratios to allow the design flexibility of a vehicle ride. Further details of an exemplary embodiment of alternative lower cushion configurations are shown and described in commonly owned U.S. Pat. No. 6,030,016-Rice, as well as other known prior art. The present invention, therefore, should not be unduly limited to the particular structural arrangement of the lower cushion as shown in the present application.

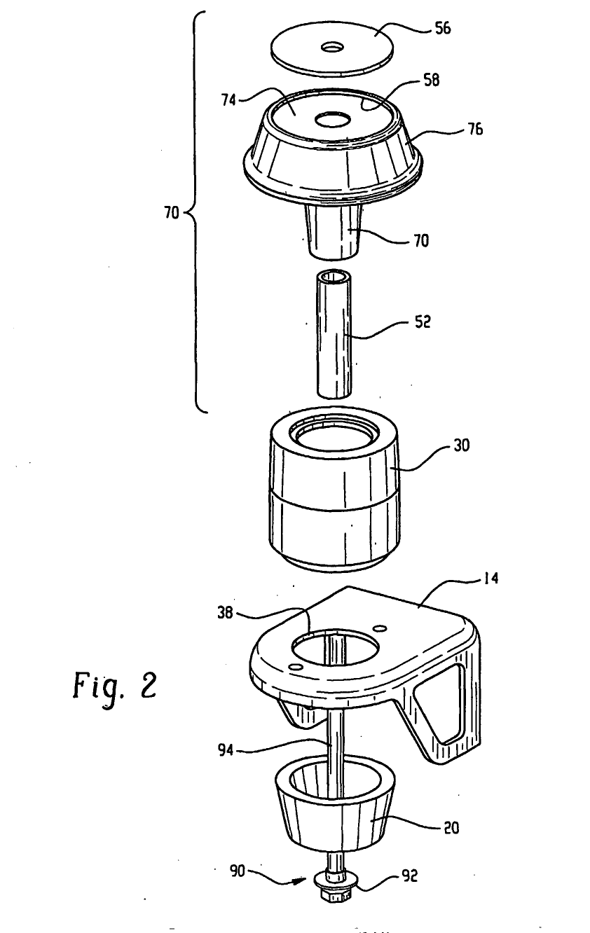

The upper body mount portion includes an upper cushion member 30. The upper cushion member is preferably molded to a metal collar 32 having a radial portion 34 adapted for engagement with an upper surface of the frame and an axial portion 36 that extends through central opening 38 in the frame. In the embodiment of FIG. 1, the upper cushion member is a hollow cylindrical configuration with a counterbore or recess 40 having a diameter slightly greater than the through opening or bore 42. Of course it will be appreciated by those skilled in the art that other configurations of the upper cushion member may be used without departing from the scope and intent of the invention. The cushion member is preferably formed of an elastomeric material that also provides desired energy damping or vibration attenuation. As perhaps best illustrated in FIG. 2, the opening 38 through the frame may be non-circular, so that the metal collar and/or upper cushion member would have a mating configured surface intended to prevent relative rotation between these components. This non-circular opening also assures proper orientation of the mount within the vehicle. As was the case with the lower cushion member, the present invention should not be limited to the particular structural arrangement of the upper cushion as shown and described herein. Rather, it will be appreciated that other configurations can be used without departing from the scope and intent of the present invention.

A helmet 50 formed in accordance with the present invention extends in at least partially overlying relation with the upper cushion member, and further includes a portion that extends into or through the hollow central opening of the upper cushion member. In the exemplary embodiment, the helmet is a composite structure that is comprised of a molded polymer or elastomeric material that includes an inner skeleton of a load bearing structural components. Here, the polymer/elastomeric material is symmetrical about a central vertical axis, although it will be recognized that the material can adopt a wide variety of different configurations as may be necessary to address the particular energy damping needs of an automotive vehicle. The inner skeleton of the helmet includes a metal, cylindrical portion 52 received in a central opening 54 of the molded polymer/elastomer material. As shown, the metal cylinder 52 is axially co-extensive with and adds increased strength to the inner diameter of the polymer/elastomer material. A metal disk or washer component 56 is another part of the metal skeletal portion of the helmet. Although it is appreciated that the disk could be integrally formed with the cylindrical portion 52, the ability to use separate, simplified structures for the metal skeletal portion of the helmet design reduces the manufacturing complexity and thereby the cost of these components. The more difficult shapes of the composite helmet that are desired can then be limited to the non-metal, molded material that forms the majority of the helmet and that can be easily modified with mold inserts or the like. The metal disk is located at an upper end of the metal cylinder for abutting engagement therewith and in the exemplary embodiment is preferably received in a recess 58 of the enlarged diameter portion of the helmet. A seal ring 60 overlies the metal disk if desired and prevents moisture from reaching the metal components of the helmet. This eliminates the need to provide a corrosive-resistant coating on the metal components, or to provide drain openings or channels in the.

The polymer/elastomer portion of the helmet includes an axially extending portion 70 that is molded over the outer diameter of the cylinder 52 along its entire length. The axially extending portion has a tapering or other complex asymmetrical shaped surface 72 over its length. Again, and as will be appreciated by those skilled in the art, it would be more difficult to form the tapering or other complex asymmetrical conformation in a metal component yet in accordance with preferred embodiment, the complex shape can be more easily accommodated. The outer surface 72 of the axial portion provides increased friction between the helmet and the upper cushion member along the interface between surfaces 72 of the helmet and the opening 42 of the upper cushion member. The increased friction results from the surface finish of the components leads to more constant tri-axial rates over time by reducing rubbing wear between the cushion and the helmet in comparison to prior arrangements.

The axial portion 70 of the helmet merges into a radial flange 74 at its first or upper end that includes a shroud or rim 76 extending downwardly from an outer periphery of the flange. The flange and shroud encase or cover the upper cushion member in substantially the same manner as a prior art metal helmet. In the embodiment of the present invention, the shroud is shown as a circumferentially continuous surface although it will be appreciated that in selected applications the shroud can be discontinuous. For example, the shroud or flange may be other complex shapes and molded thereabout to address different forces imposed on the cushion assembly.

A fastener or mounting bolt 90 includes enlarged head 92 at a first end and an elongated shank 94 extending therefrom that passes through the clamp disk, lower cushion member, upper cushion member, and the metal cylinder 52 disposed in the axial portion of the helmet. A terminal end of the shank protrudes or extends outwardly from the upper end, i.e., through the metal washer 56, and may be externally threaded for cooperation with a threaded fastening nut (not shown) or otherwise secured at its terminal end to hold the individual components of the composite helmet together.

FIG. 2 illustrates the individual components of the body mount assembly in an exploded view. The seal ring 60 can be molded into the assembly for assembly plant convenience, i.e., to hold the fastener in place and facilitate handling.

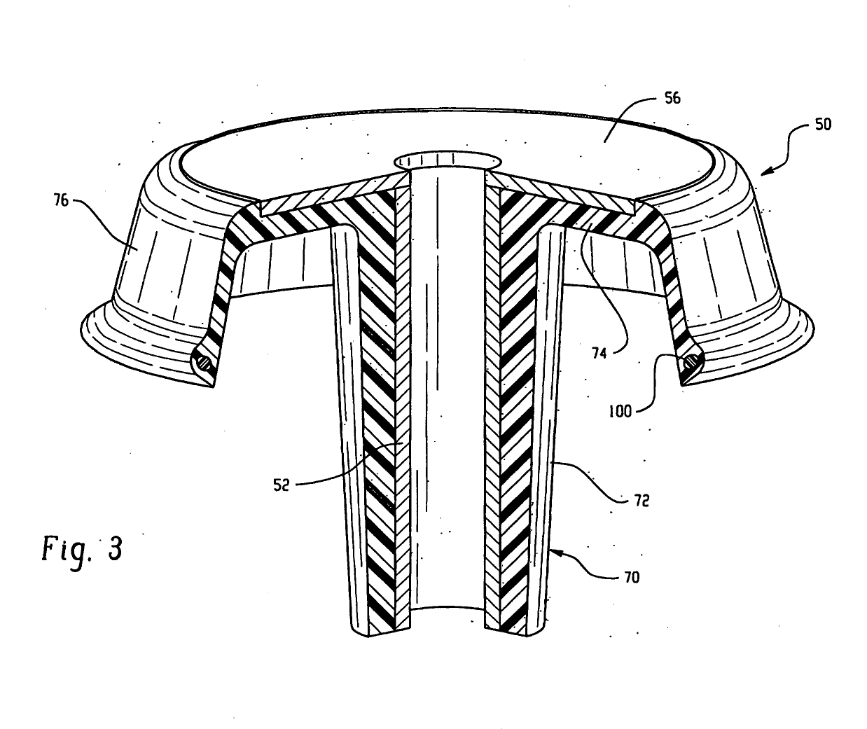

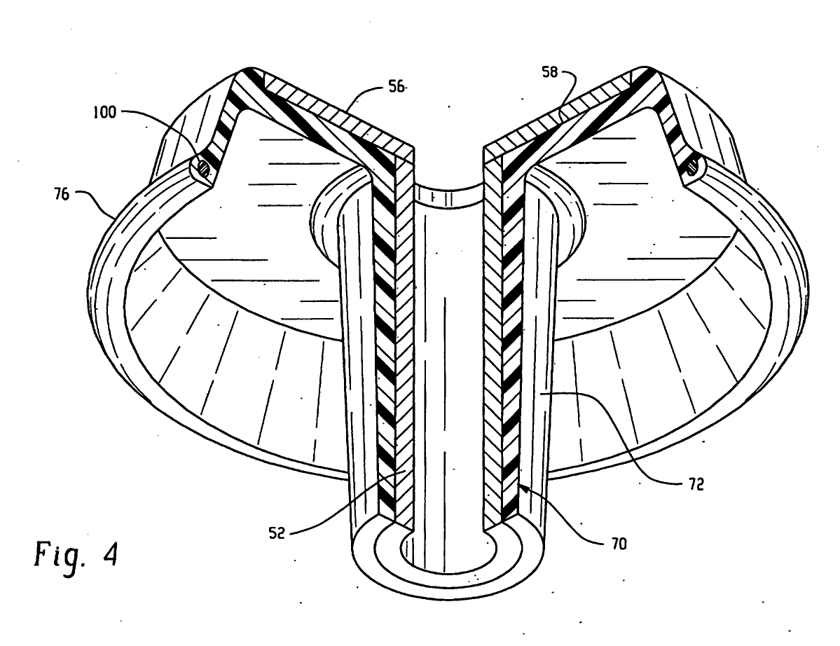

The profile of the helmet, and for example, the shroud 76, can also be modified as demonstrated in FIGS. 3 and 4. As shown here, the lower ridge is slightly enlarged to receive a strengthening ring, such as glass reinforced nylon ring 100, molded therein. The ring provides increased rigidity or strength and stability to the structure while maintaining encapsulation of the metal components to limit problems with corrosion, and it will be appreciated that the particular conformation or material of construction need not be limited to the nylon ring as sown and described. Moreover, the ring only defines a minor portion of the shroud so that the total mass of the assembly is minimized.

In this manner and in accordance with the present invention, a known body mount helmet typically constructed from a single piece of deep-drawn steel is replaced with an assembled, molded arrangement having an interior metal skeleton that does not corrode, does not produce clanging associated with the prior metal helmets, temporarily retains a bolt in place, has a substantially reduced mass relative to the prior all-metal version, and allows great flexibility to introduce different levels of pre-compression in differing directions of the cushion, i.e., allowing for greater system tuning flexibility if desired. In addition, the invention allows the use of a common skeletal member without sacrificing tuning abilities, and can potentially significantly reduce tool cost and lead time by eliminating expensive and complicated deep-draw dies. Development of components or parts is accelerated and due to the molded nature of the component, interior features can be easily molded into the assembly, e.g., to hold the fastener in place temporarily. The inner skeleton or structural load bearing assembly includes an elongated support portion 70 and a radial portion 56 in load bearing relation therewith, that is received in a moldable material. The moldable material is a hard EPDM elastomer in the preferred arrangement but any moldable substance such as thermoplastics, glass reinforced nylon, etc., can be used depending on the rigors of the application. Likewise, although the inner skeleton is shown and described in the preferred embodiment as a metal, other structural materials suitable to load conditions can be used interchangeably.

The invention has been described with reference to the preferred embodiment. Obviously, modifications and alterations will occur to others upon reading and understanding the preceding detailed description. It is intended that the invention be construed as including all such modifications and alterations.

1. A vibration isolator comprising:
a cushion assembly including a first cushion member operatively mounted to an associated vehicle frame; and
a composite helmet at least partially overlying and extending through the first cushion member and including a structural load bearing assembly for receiving torque from an associated fastener that secures the cushion assembly and helmet together, the load bearing assembly including an elongated support portion and a radial portion in load bearing relation with the elongated support portion for transferring loads therebetween, and a moldable material received around at least portions of the load bearing assembly.

2. The vibration isolator of claim 1 wherein the elongated support portion is a generally cylindrical member that extends into the cushion assembly.

3. The vibration isolator of claim 2 wherein the elongated support portion is a metal cylinder.

4. The vibration isolator of claim 3 wherein the radial portion is an annular disk having a central opening dimensioned to receive the associated fastener therethrough.

5. The vibration isolator of claim 4 wherein the disk is metal and abuttingly engages the metal cylinder.

6. The vibration isolator of claim 1 wherein the radial portion is an annular disk having a central opening dimensioned to receive the associated fastener therethrough.

7. The vibration isolator of claim 6 wherein the disk is metal and abuttingly engages a metal cylinder.

8. The vibration isolator of claim 1 wherein the moldable material is a polymer.

9. The vibration isolator of claim 1 wherein the moldable material is an EPDM.

10. The vibration isolator of claim 1 wherein the moldable material encases the structural load bearing assembly to seal the structural load bearing assembly from moisture.

11. The vibration isolator of claim 10 wherein the moldable material includes a shroud extending about the periphery of the radial portion and partially enclosing the cushion assembly.

12. The vibration isolator of claim 11 wherein the shroud includes a high tensile strength insert therein.

13. The vibration isolator of claim 1 wherein the elongated support portion extends axially outward from the radial portion, the elongated support portion extending into the cushion assembly and the radial portion abutting one end of the cushion assembly.

14. The vibration isolator of claim 13 wherein the moldable material encases the elongated support portion and the radial portion to seal the structural load bearing assembly from moisture.

15. A vibration isolator for damping vibration energy between an associated automotive component and an associated vehicle frame, the vibration isolator including:
a generally annular cushion assembly dimensioned for receipt between the associated automotive component and the associated vehicle frame, the cushion assembly being adapted for engagement with the associated vehicle frame;
a composite helmet interposed between one of the associated automotive component and the associated vehicle frame and the cushion assembly, the helmet including a load bearing skeleton at least partially received in the cushion assembly and a moldable polymer received at least partially therearound.

16. The vibration isolator of claim 15 wherein the load bearing skeleton includes an elongated stiffener extending through the annular cushion assembly.

17. The vibration isolator of claim 16 wherein the elongated stiffener is a metal construction.

18. The vibration isolator of claim 16 wherein the load bearing skeleton includes a disk in abutting engagement with one end of the stiffener.

19. The vibration isolator of claim 18 wherein the disk is a metal construction.

20. A method of manufacturing a helmet of a vibration isolator, the method comprising the steps of:
providing a cushion assembly having a first cushion member adapted for engagement with an associated vehicle frame;
providing a load bearing skeleton; and
forming a moldable material around the skeleton configured to extend into the cushion assembly and at least partially enshroud one end of the cushion assembly.

21. The vibration isolator of claim 1 wherein the radial portion is an annular disk received in a recess defined by the moldable material.
